(19) United States
(12) Patent Application Publication
(10) Pub. No.: US 2025/0197266 A1
(43) Pub. Date: Jun. 19, 2025

(54) ALTERNATIVE DIRECT POTABLE REUSE TRAIN

(71) Applicant: Black & Veatch Holding Company, Overland Park, KS (US)

(72) Inventors: Ufuk Goksin Erdal, Irvine, CA (US); Zeynep Erdal, Irvine, CA (US); Leon Scott Downing, Overland Park, KS (US)

(21) Appl. No.: 18/979,985

(22) Filed: Dec. 13, 2024

Related U.S. Application Data
(60) Provisional application No. 63/610,596, filed on Dec. 15, 2023.

(51) Int. Cl. C02F 9/00; C02F 1/28; C02F 1/44; C02F 1/72; C02F 3/00; C02F 101/32

(52) U.S. Cl. CPC C02F 9/00; C02F 1/283; C02F 1/444; C02F 1/72; C02F 3/00; C02F 2101/322

(57) ABSTRACT

Wastewater treatments and facilities are provided that utilize a seed reactor and a granular activated carbon system to facilitate and enhance the removal of specific low molecular weight compounds that are slowly biodegradable, including the four compounds required for direct potable reuse chemical compliance. More specifically, the wastewater treatments and facilities described herein can obtain at least a 1-log (90 percent) removal of low molecular weight compounds, such as acetone, formaldehyde, carbamazepine, and sulfamethoxazole, from wastewater streams.

### RELATED APPLICATIONS

This application claims the priority benefit under 35 U.S.C. § 119(e) of U.S. Provisional Patent Application Ser. No. 63/610,596 entitled “ALTERNATIVE DIRECT POTABLE REUSE (DPR) TRAIN TO MEET CHEMICAL CONTROL CRITERIA OF CALIFORNIA DPR REGULATIONS,” filed Dec. 15, 2023, the entire disclosure of which is incorporated herein by reference.

### BACKGROUND

### 1. Field of the Invention

The present disclosure generally relates to wastewater treatments and systems. More particularly, the present disclosure generally relates to wastewater treatments and systems capable of more efficiently and economically removing low molecular weight compounds from wastewater.

### 2. Description of the Related Art

The California Draft DPR Regulations effective in October of 2024 require direct potable reuse (“DPR”) trains to include an ozone treatment system and a biologically activated carbon (“BAC”) system prior to reverse osmosis (“RO”) and advanced oxidation processes (“AOP”). The main interest associated with this proposed ozone/BAC configuration is to further remove chemicals, including small and uncharged organic compounds such as acetone and formaldehyde, which are not significantly removed by conventional RO membranes and AOP. While efficacy of this ozone/BAC configuration for controlling chemicals has been well proven, inclusion of these additional systems in a potable reuse train can substantially increase carbon footprint, operational complexity, space requirement, and cost of the trains. Thus, the California Draft DPR Regulations provide provisions to use alternatives, if the proposed alternatives provide an equivalent or better level of performance with respect to the efficacy and reliability of the removal of contaminants of public health concern and assures at least the same level of protection to public health.

However, traditional wastewater treatment plants are not typically designed or operated to remove specific compounds, such as acetone and formaldehyde. Rather, such plants are designed to remove gross pollutants, such as five-day biochemical oxygen demand (BOD5), total suspended solids (TSS), ammonia-nitrogen, and phosphorus. Thus, there are no existing traditional wastewater treatment technologies that are proven to achieve very high degree removal (e.g., a minimum of 90%) of low molecular weight organic compounds, such as acetone and formaldehyde, which are identified by the California State Water Board Division of Drinking Water (“DDW”) as performance indicators for chemical control.

Furthermore, present technologies, such as wastewater systems utilizing an ozone system and a BAC system, exhibit several deficiencies and concerns, including increased risk of bromate and other disinfection byproduct formation, along with increased cost, footprint, and operational complexity. Furthermore, traditional wastewater treatment technologies are inadequate at targeting and removing specific low molecular weight compounds, including those highlighted by the DDW. Thus, traditional wastewater treatment technologies cannot provide a minimum 1-log (90 percent) removal of acetone, formaldehyde, and other low molecular weight organic compounds from wastewater streams consistently.

Accordingly, there is a need for alternative wastewater treatment systems and methods that can target and remove specific low molecular weight compounds from wastewater streams.

### SUMMARY

One or more embodiments of the present invention generally concern a method for removing low molecular weight compounds from wastewater. Generally, the method comprises: (a) introducing an initial wastewater stream into a bioreactor to form a first treated wastewater stream, wherein the initial wastewater stream comprises a first low molecular weight compound content, wherein the low molecular weight compounds comprise acetone, formaldehyde, carbamazepine, sulfamethoxazole, or a combination thereof; (b) introducing the first treated wastewater stream into a solids separation unit to form a clarified wastewater stream; (c) treating at least a portion of the clarified wastewater stream in a seed reactor to thereby form a treated sludge byproduct; (d) treating at least a portion of the treated sludge byproduct in the bioreactor to form a second treated wastewater; (e) treating at least a portion of the second treated wastewater in a granular activated carbon (“GAC”) system to thereby form a GAC-treated stream; and (f) treating at least a portion of the GAC-treated stream in an oxidation system to thereby form a treated water stream comprising a second low molecular weight compound content, wherein the second low molecular weight compound content is at least 90 percent lower than the first low molecular weight compound content.

One or more embodiments of the present invention generally concern a method for removing low molecular weight compounds from wastewater. Generally, the method comprises: (a) introducing an initial wastewater stream into a bioreactor to form a first treated wastewater stream, wherein the initial wastewater stream comprises a first low molecular weight compound content, wherein the low molecular weight compounds comprise acetone, formaldehyde, carbamazepine, sulfamethoxazole, or a combination thereof; (b) introducing at least a portion of the first treated wastewater stream into a solids separation unit to form a first clarified wastewater stream; (c) treating at least a portion of the clarified wastewater stream in a seed reactor to thereby form a treated sludge byproduct; (d) treating at least a portion of the treated sludge byproduct in the bioreactor to form a second treated wastewater; (e) treating at least a portion of the second treated wastewater in the solids separation unit to thereby form a second clarified wastewater stream; (f) optionally introducing at least a portion of the second clarified wastewater stream into the seed reactor; (g) treating at least a portion of the second clarified wastewater stream in a microfiltration system to thereby form a microfiltrated stream; (h) treating at least a portion of the microfiltrated stream in a reverse osmosis system to thereby form an RO-treated stream; (i) treating at least a portion of the RO-treated stream in a granular activated carbon (“GAC”) system to thereby form a GAC-treated stream; and (j) treating at least a portion of the GAC-treated stream in an oxidation system to thereby form a treated water stream comprising a second low molecular weight compound content, wherein the second low molecular weight compound content is at least 90 percent lower than the first low molecular weight compound content.

One or more embodiments of the present invention generally concern a wastewater treatment system for removing low molecular weight compounds from wastewater. Generally, the system comprises: (a) a bioreactor configured to receive an initial wastewater stream and thereby form a first treated wastewater stream, wherein the initial wastewater stream comprises a first low molecular weight compound content, wherein the low molecular weight compounds comprise acetone, formaldehyde, carbamazepine, sulfamethoxazole, or a combination thereof; (b) a solids separation unit in downstream fluid communication with the bioreactor and configured to receive at least a portion of the first treated wastewater stream and thereby form a clarified wastewater stream; (c) a seed reactor configured to treat at least a portion of the clarified wastewater stream and thereby form a treated byproduct, wherein the seed reactor is in fluid communication with the bioreactor and the solids separation unit, wherein the bioreactor is configured to receive and treat at least a portion of the treated byproduct from the seed reactor; (d) a granular activated carbon (“GAC”) system in downstream fluid communication with the solids separation unit and configured to receive and treat at least a portion of the clarified wastewater stream and thereby form a GAC-treated stream; and (e) an oxidation system configured to receive and treat at least a portion of the GAC-treated stream and thereby form a treated water stream comprising a second low molecular weight compound content, wherein the second low molecular weight compound content is at least 90 percent lower than the first low molecular weight compound content.

### BRIEF DESCRIPTION OF THE FIGURES

Embodiments of the present invention are described herein with reference to the following drawing figures, wherein:

FIG. 1 depicts an existing wastewater treatment system that utilizes an ozone treatment systema and a biological activated carbon (“BAC”) system to remove various pollutants from wastewater streams;

FIG. 2 depicts an exemplary wastewater treatment system in accordance with one embodiment of the present disclosure; and

FIG. 3 depicts another exemplary wastewater treatment system in accordance with one embodiment of the present disclosure.

### DETAILED DESCRIPTION

The present invention solves the above-described problems and provides a distinct advance in the art of wastewater treatment. Due to the inventive wastewater treatments and facilities described herein, wastewater treatment plants are now capable of removing specific low molecular weight compounds that are slowly biodegradable, including the four compounds required by DDW for direct potable reuse (“DPR”) chemical compliance, i.e., acetone, formaldehyde, carbamazepine, and sulfamethoxazole. As used herein, “low molecular weight compounds” refer to organic chemical compounds with a molecular weight of less than 100 Daltons. Generally, the low molecular weight compounds can include, for example, haloalkanes (e.g., methyl bromide), alcohols (e.g., methanol and/or ethanol), aldehydes (e.g., formaldehyde), ketones, acetonitrile, THMs, and/or methyl isothiocyanate (“MITC”). As discussed below, the inventive wastewater treatments and facilities described herein can obtain at least a 1-log removal of specific low molecular weight compounds, such as acetone, formaldehyde, carbamazepine, and sulfamethoxazole, from wastewater streams.

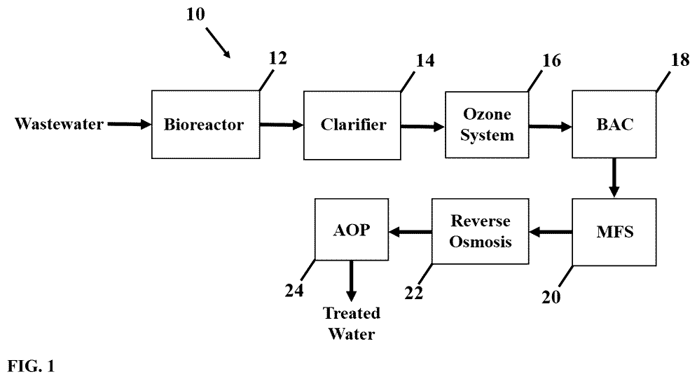

As shown in FIG. 1, existing wastewater treatment systems 10 typically utilize an ozone system 16 and biological activated carbon (“BAC”) system 18, along with a bioreactor 12, solids separation unit 14, microfiltration system (“MFS”) 20, a reverse osmosis system 22, and an advanced oxidation process (“AOP”) 24. However, these existing systems can exhibit operational and fiscal inefficiencies due to the use of the ozone system and BAC system. In contrast, the inventive wastewater treatments and facilities described herein are more adaptable to varying types of wastewater feeds and permit the exclusion of the ozone system and BAC system, while still allowing the selective removal of low molecular weight compounds from the wastewater. Thus, the inventive wastewater treatments and facilities described herein can achieve operational and economic efficiencies that are not obtainable by existing systems.

As described herein, the inventive wastewater treatments and facilities can obtain these efficiencies based on the incorporation of one or more seed reactors and at least one granular activated carbon (“GAC”) system into the facilities. It has been observed that the seed reactor may enhance secondary treatment performance in a way that has not been demonstrated in municipal applications and DPR trains. More particularly, seed material (e.g., bacteria acclimated to remove specific organic compounds) may be developed in the seed reactors in the presence of a target compound and then transferred to the main bioreactors so as to facilitate the removal of target compounds. Furthermore, it has also been observed that the incorporation of one or more seed reactors and GAC system also eliminate the need for the ozone system and the BAC system in the DPR train, as the presence of the inventive wastewater treatments and facilities allows for at least 90 percent removal of low molecular weight compounds, such as acetone, carbamazepine, sulfamethoxazole, and/or formaldehyde, from the initial wastewater streams. Thus, with very little investment and minor modifications, the inventive wastewater treatments and facilities can remove at least 90 percent of undesirable low molecular weight compounds from wastewater streams and enhance operational efficiencies of the DPR train.

FIG. 2 depicts an exemplary embodiment of the inventive wastewater facility of the present disclosure. As discussed below in greater detail, the train configuration presented in FIG. 2 has the great potential of meeting chemical control requirements, while also significantly reducing space requirements, operational complexity, energy requirements, and project cost. It should be understood that FIG. 2 depicts one exemplary embodiment of the present technology. Certain features depicted in FIG. 2 may be omitted and/or additional features described elsewhere herein may be added to the system depicted in FIG. 2. The various process steps are described below in greater detail.

As shown in FIG. 2, a wastewater stream 101 may be introduced into a bioreactor 112 of the wastewater treatment facility 100. The wastewater stream 101 may be derived from any known source, including municipal and/or industrial sources. Although FIG. 2 depicts only a single bioreactor 112, additional bioreactors may be present. For example, in one or more embodiments, the facility may have a plurality of bioreactors, such as at least two, three, or four bioreactors. The bioreactors may include any known bioreactor in the art that supports a biologically active environment for bacteria and protozoa to grow and consume wastewater substances. In various embodiments, the bioreactor can be an aerobic, an anoxic, and/or an anaerobic reactor. In certain embodiments, the bioreactor can be a membrane bioreactor, such as a submerged membrane bioreactor and/or a side stream membrane bioreactor.

Turning again to FIG. 2, the first wastewater treated stream exiting the bioreactor 112 may then be introduced into at least one solids separation unit 114. The solids separation unit 114 is utilized to remove solid particulates or suspended solids from the influent stream for clarification and/or thickening. Although FIG. 2 depicts only a single solids separation unit 114, additional solids separation units may be present. For example, in one or more embodiments, the facility may have a plurality of solids separation units, such as at least two, three, or four solids separation units. The solids separation units can be any solids separation unit known in the art, such as a clarifier. In one or more embodiments, the solids separation unit can be an upflow solids separation unit, a lamella solids separation unit, a primary solids separation unit, a solid contact solids separation unit, a circular solids separation unit, a rectangular solids separation unit, a clariflocculator, and/or a membrane-based activated sludge separation system.

As shown in FIG. 2, at least a portion or the entire of the clarified wastewater stream 120 may be diverted via conduit 122 to at least one seed reactor 116. In one or more embodiments, the clarified wastewater stream 120 diverted via conduit 122 can comprise the settled solids from the solids separation unit 114. In such embodiments, the clarified wastewater stream 120 can be predominantly formed from the underflow from the solids separation unit 114.

Prior to introducing the clarified wastewater stream into the seed reactor 116, a stream of target compounds may be combined with at least a portion of the clarified wastewater stream in conduit 122. Additionally, or in the alternative, a stream of target compounds may be added directly to the seed reactor 116 separately from the clarified wastewater stream. The stream of target compounds can be an aqueous mixture of various target compounds that are slowly biodegradable, such as acetone, formaldehyde, methanol, and/or ethanol. It has been observed that the addition of this target compound stream at this junction can enhance the efficiencies of the facility and the resulting removal of undesirable chemical compounds from the wastewater. The target compound stream can be derived from any source, including from byproduct streams and waste streams derived from the facility 100.

In one or more embodiments, the target compound stream comprises water and at least one slowly biodegradable chemical compound, such as acetone, formaldehyde, methanol, and/or ethanol. In various embodiments, the target compounds can be organic compounds having a molecular weight of less than 100 Daltons, an Octanol water partition coefficient of less than 1 log Kow, and/or a resistance to photolysis and advanced oxidation.

In one or more embodiments, the target compound stream may comprise at least 25, 50, 75, or 100 mg/L and/or less than 500, 400, 300, 250, or 200 mg/L COD equivalent of acetone, formaldehyde, ethanol, methanol, or any combination of two or more thereof. In certain embodiments, the target compound stream comprises: (1) 75 to 200 mg/L COD equivalent of an acetone and formaldehyde mixture, (2) 75 to 200 mg/L COD equivalent of acetone only, (3) 75 to 200 mg/L COD equivalent of formaldehyde only, (4) 75 to 200 mg/L COD equivalent of methanol only, or (5) 75 to 200 mg/L COD equivalent of ethanol only.

In one or more embodiments, the influent into the seed reactor may comprise at least 10, 15, 20, 25, 30, 35, 40, 45, 50, 55, 60, 65, 70, 75, 80, 85, or 90 weight percent and/or less than 99.5, 99, 98, or 95 weight percent of the clarified wastewater stream, based on the total influent stream going into the seed reactor. Additionally, or in the alternative, the influent into the seed reactor may comprise at least 0.1, 0.5, 1, 2, 3, 4, or 5 weight percent and/or less than 90, 80, 70, 60, 50, 40, 35, 30, 25, 20, 15, or 10 weight percent of the target compound stream, based on the total influent stream going into the seed reactor.

While in the seed reactor 116, the wastewater influent may be further treated so as to produce a treated sludge byproduct, which can be a waste activated sludge (“WAS”). In certain embodiments, the treated sludge byproduct from the seed reactor 116 can be a membrane bioreactor (“MBR”) activated sludge.

Although FIG. 2 depicts only a single seed reactor 116, additional seed reactors may be present and utilized. For example, in one or more embodiments, the facility may have a plurality of seed reactors, such as at least two, three, or four seed reactors and/or less than eight, seven, six, five, or four seed reactors. In one or more embodiments, the seed reactor comprises a sequencing batch reactor (“SBR”) and/or a biofilm reactor. In various embodiments, the wastewater influent may be treated in the seed reactor for at least 2, 3, 4, 5, 6, 7, 8, 9, 10, 11, 12, 13, 14, 15, 16, 17, 18, 19, 20, 21, 22, 23, or 24 hours and/or less than 48, 42, 36, or 30 hours.

In one or more embodiments, the seed reactor 116 may comprise an SBR. SBRs are known for their efficiency, flexibility, and effluent quality. They can be used for both domestic and commercial wastewater and are a good choice for projects that require high performance with minimal energy use. In many cases, an SBR performs equalization, biological treatment, and secondary clarification in a single tank using a timed control sequence.

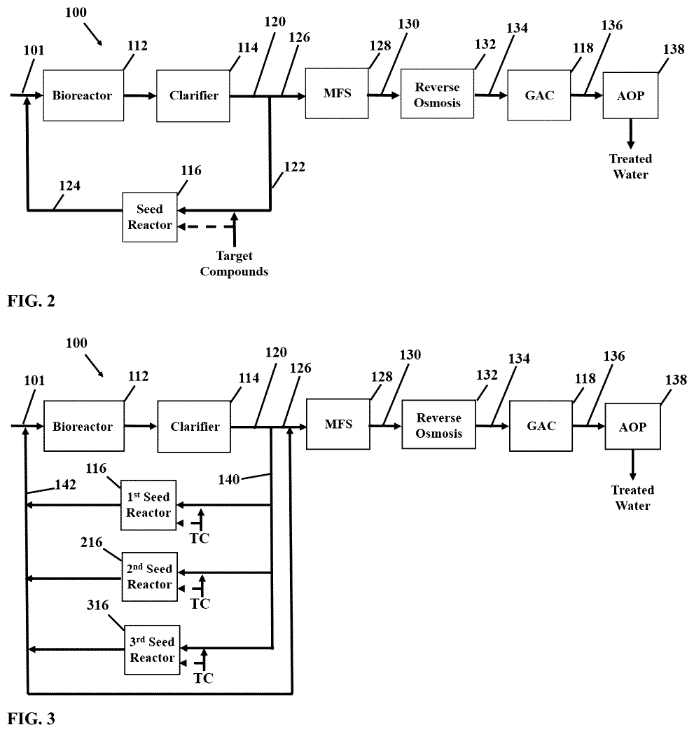

In one or more embodiments, the SBR comprises a tank, aeration and mixing equipment, a decanter, and a control system. Generally, the SBR involves a wastewater treatment that uses microorganisms to treat wastewater in batches. The SBR may treat wastewater in a single tank or a plurality of tanks, such as at least two, three, or four separate tanks, using a specific volume of wastewater at a time. Equalization, aeration, and clarification can all be achieved using a single SBR; however, to optimize the performance of the facility, at least two, three, or four SBRs may be used in a predetermined sequence of operations. This configuration is discussed below in regard to FIG. 3.

The treatment steps may be sequenced in time, and the SBR system can remove organic matter, nitrogen, and phosphorus from the wastewater. While in the SBR, oxygen may be bubbled throughout the mixture of wastewater and activated sludge in order to reduce the organic matter, as measured via biochemical oxygen demand (“BOD”) and/or chemical oxygen demand (“COD”). As shown in FIG. 2, the treated effluent 124, i.e., the waste activated sludge (“WAS”) may be reintroduced into the bioreactor 112 for further processing.

Typically, the wastewater is introduced into a partially filled SBR containing biomass, which is acclimated to the wastewater constituents during preceding cycles. Once the SBR is full, it can behave like a conventional activated sludge system, but without a continuous influent or effluent flow. The aeration and mixing may be discontinued after the biological reactions are complete, the biomass settles, and the treated supernatant is removed.

Generally, the operation of an SBR is based on the fill-and-draw principle, which comprises the following five basic steps: Idle, Fill, React, Settle, and Draw. The Idle step occurs between the Draw and the Fill steps, during which treated effluent is removed and influent wastewater is added. The length of the Idle step varies depending on the influent flow rate and the operating strategy. Equalization is achieved during this step if variable idle times are used. Mixing to condition the biomass and sludge wasting can also be performed during the Idle step, depending on the operating strategy.

Influent wastewater may be added to the reactor during the Fill step. The following three variations are used for the Fill step and any or all of them may be used depending on the operating strategy: static fill, mixed fill, and aerated fill. During static fill, influent wastewater may be added to the biomass already present in the SBR. Static fill is characterized by no mixing or aeration, meaning that there will be a high substrate (food) concentration when mixing begins. A high food to microorganisms ratio creates an environment favorable to floc forming organisms versus filamentous organisms, which provides good settling characteristics for the sludge. Mixed fill is classified by mixing influent organics with the biomass, which initiates biological reactions. During mixed fill, bacteria biologically degrade the organics and use residual oxygen or alternative electron acceptors, such as nitrate nitrogen.

Settle is typically provided under quiescent conditions in the SBR. In one or more embodiments, gentle mixing during the initial stages of settling may result in a clearer effluent and a more concentrated settled sludge. Generally, in an SBR, there are no influent or effluent currents to interfere with the settling process as in a conventional activated sludge system.

Alternatively, in one or more embodiments, the seed reactor 116 may comprise a biofilm reactor. In various embodiments, the biofilm reactor may be a moving bed biofilm reactor, a membrane biofilm reactor, a fixed bed biofilm reactor, or a fluidized bed reactor. Generally, biofilm reactors may comprise attached growth systems wherein microbial communities grow on the surface of a solid substratum (e.g., sand, activated carbon, etc.), which is damped by the influent wastewater.

In most cases, the influent enters the basin of the biofilm reactor at the beginning of treatment. The media within the biofilm reactor may comprise free-floating biocarriers, which can occupy as much as 70 percent of the tank. Additionally, an aeration grid may be present and responsible for moving the media through the tank and ensure the carriers contact as much influent as possible, in addition to introducing more oxygen into the tank. Lastly, a sieve may keep all the carriers in the tank to prevent the carriers from escaping the aeration.

In one or more embodiments, the biomass in the biofilm reactor is acclimated to low molecular weight compounds in a cyclic operation. In such embodiments, one of multiple seed reactors may be fed in seeding mode, where target compounds (e.g., tetracycline) are added to the reactor to grow acclimated biomass, and the effluent of the seed reactor is sent back to the main bioreactor 112. For the other seed biofilm reactors, all or a portion of the effluent from the solids separation unit 114 may be directed to the biofilm reactor 112, and effluent from the bioreactor 112 proceeds to the downstream treatment processes.

Turning again to FIG. 2, at least a portion or the entirety of the treated sludge stream 124 may be introduced back into the bioreactor 112, along with the wastewater influent stream 101. Alternatively, in one or more embodiments, at least a portion or the entirety of the treated sludge stream 124 may be introduced back into the bioreactor 112 without first commingling with the wastewater influent stream 101. Consequently, the treated sludge stream 124 from the seed reactor 116 may be further treated in the bioreactor 112.

Subsequently, as shown in FIG. 2, the treated sludge stream 124 may be commingled with the wastewater influent stream 101 and treated in the bioreactor 112 and solids separation unit 114, as discussed above. After second treatment within the solids separation unit 114, at least a portion of or the entirety of the second clarified wastewater stream 120 may be sent to the seed reactor 116 for further processing and/or downstream to a membrane system (“MFS”) 128. As shown in FIG. 2, the second clarified stream 126 may be sent to the MFS 128. It has been observed that returning all of the treated sludge from the seed reactor(s) to the bioreactor may promote maintenance of more competent biomass in the mainstream, which can enhance the biodegradation of the slowly biodegradable and low molecular weight compounds. Thus, in certain embodiments, there may be little or no wastage from the seed reactor.

The MFS 128 can include any microfiltration or ultrafiltration known and used in the art. Generally, the MFS utilizes a low-pressure membrane with pores small enough to filter out particles of a certain size from the second clarified stream 126. Although FIG. 2 depicts only a single MFS 128, additional MFS units may be present and utilized. For example, in one or more embodiments, the facility may have a plurality of MFS units, such as at least two, three, or four MFS units. The MFS filter pore sizes are generally two to three order of magnitude larger than those of the low molecular weight organic compounds, such as acetone and formaldehyde. Thus, MFS systems are not effective by themselves in removing the target low molecular organic compounds.

As shown in FIG. 2, at least a portion of or the entirety of the MFS-treated stream 130 may be introduced into a reverse osmosis (“RO”) unit 132 for further treatment. Generally, RO systems use pressure to force water through semi-permeable membranes that remove impurities. Ideally, the water that passes through the membrane is largely free of contaminants. However, compounds having no electrical charges and that are smaller than the molecular weight cutoff of the RO membranes (typically 100 to 150 Daltons) can pass through the RO membranes. Examples of compounds that can pass RO membranes include carbon dioxide, acetone, and formaldehyde.

The RO unit 132 can include any RO unit known and used in the art. The membranes in the RO unit 132 can also include those known in the art, including a polyamide/polysulfone/non-woven PET fabric membrane construct. Although FIG. 2 depicts only a single RO unit 132, additional RO units may be present and utilized. For example, in one or more embodiments, the facility may have a plurality of RO units, such as at least two, three, or four RO units.

Turning again to FIG. 2, at least a portion of or the entirety of the RO-treated stream 134 from the RO unit 132 may be introduced into at least one granular activated carbon (“GAC”) system 118. The GAC system 118 may remove contaminants from the RO-treated stream 134 via adsorption. The GAC systems 118 provides a polishing step for leftover organic compounds, if present, so as to meet stringent drinking water standards

Generally, GAC is used in a column and/or tank to filter contaminated water. Ideally, the contaminants will stick to the GAC's inner and outer surfaces. GAC can remove dissolved organics, inorganic compounds, and chemicals that cause bad tastes or odors. When the GAC is no longer effective, it can be regenerated or replaced with fresh GAC. Regeneration methods may include, for example, thermal, chemical, microbiological, vacuum, electric, electrochemical, and/or supercritical fluid treatments. One advantage of the inventive facility described herein is that it can significantly reduce GAC replacement due to the low total organic compound (“TOC”) content of the RO-treated stream, which is typically less than 0.25 mg/L. This is derived from the setup described herein, particularly due to the seed reactor configuration.

The GAC system 118 can include any GAC system known and used in the art. For example, the GAC system 118 may include a pressurized tank with at least one bed of GAC. In one or more embodiments, the GAC may be manufactured from bituminous coal, lignite coal, peat, wood, and/or coconut shells. Although FIG. 2 depicts only a single GAC system 118, additional GAC systems may be present and utilized. For example, in one or more embodiments, the facility may have a plurality of GAC systems, such as at least two, three, or four GAC systems.

It should be noted that the GAC system 118 generally differs from biologically activated carbon (“BAC”) systems based on modes of operation. For instance, GAC systems generally function based on adsorption, while BAC systems focus on biodegradation. In one or more embodiments, the RO-treated stream 134 may be present in the GAC system 118 for less than 15, 14, 13, 12, 11, 10, 9, 8, 7, 6, 5, 4, 3, or 2 minutes.

Due to the use of the seed reactors and the configuration described herein, the GAC-treated stream 136 may exhibit superior UV transmittance (prior to subsequent treatment in the AOP unit 138) relative to prior art systems. Consequently, this superior UV transmittance can reduce the AOP reactor size and operating UV dose, which can result in significant capital and operating savings. In one or more embodiments, the GAC-treated stream 136 can exhibit a UV transmittance of at least 96%, 97%, 98%, or 99%.

Turning once more to FIG. 2, at least a portion of or the entirety of the GAC-treated stream 136 may be introduced into at least one advanced oxidation process (“AOP”) unit 138. Generally, the AOP unit 138 utilizes chemical treatments that use powerful oxidants to break down pollutants in wastewater.

The AOP unit 138 can include any AOP unit known and used in the art. In one or more embodiments, the AOP unit 138 may combine UV photolysis with chemical oxidation such that addition of hydrogen peroxide or chlorine prior to AOP reactor can create hydroxyl radicals that can react with organic compounds and oxidize them. In one or more embodiments, the AOP unit may utilize UV radiation, fenton, electrochemical processes, photolysis, and/or sonolysis. Although FIG. 2 depicts only a single AOP unit 138, additional AOP units may be present and utilized. For example, in one or more embodiments, the facility may have a plurality of AOP units, such as at least two, three, or four AOP units.

Due to the facility configuration described herein and depicted in FIG. 2, the resulting treated water stream from the AOP unit 138 may exhibit a very low content of the low molecular weight compounds described herein, particularly of acetone, formaldehyde, carbamazepine and/or sulfamethoxazole. In one or more embodiments, the resulting treated water stream from the AOP unit 138 may contain a low molecular weight compound content that is at least 90, 91, 92, 93, 94, 95, 96, 97, 98, or 99 percent lower than the low molecular weight compound content of the wastewater influent 101 introduced into the facility 100. These percentages may be based on weight percentages or volume percentages. It should be noted that these percentages may be based on any one of the noted low molecular weight compounds (e.g., acetone, formaldehyde, carbamazepine or sulfamethoxazole) or any combination of two or more of these compounds.

In one or more embodiments, and as shown in FIG. 2, the facility 100 does not contain an ozone treatment system and/or a BAC treatment system. In regard to the exclusion of BAC in such embodiments, this means that the facility 100 does not contain any BAC.

FIG. 3 depicts an alternative embodiment of the present disclosure depicting a facility 100 with multiple seed reactors 116, 216, and 316. As shown in FIG. 3, the clarified stream 140 may be partitioned and introduced into any one of seed reactors 116, 216, and 316. As noted above, the clarified stream 140 may include the settled and recycled solids (e.g., return activated sludge) from the solids separation unit 114. As noted above, the intent is to grow seed material (e.g., acclimated bacteria) in these seed reactors, and then send this seed material back to the bioreactor 112, where it can facilitate the removal of the low molecular weight organic compounds.

In certain embodiments, the seed reactors 116, 216, and 316 may be biofilm systems with fixed media carriers, which facilitate the growth of biomass and accumulation of enzymes. In systems with multiple seed reactors, one reactor 116 may be in settle/decant mode, while the other seed reactors 216, 316 may be aerating and filling.

In various embodiments, the acclimation in FIG. 3 may occur offline in a seeding reactor with the introduction of the target compound stream, which may include acetone or other organic compounds. This can avoid the need to feed the target organic compounds directly to the treated sludge and/or mainstream process as the acclimation occurs in the offline seed reactor. Additionally, in various embodiments, the seed reactors 116, 216, and 316 may receive secondary and/or tertiary effluent wastewater prior to reintroduction into the mainstream into the bioreactor 112. Thus, any one of the seed reactors in FIG. 3 may operate online or offline. In offline mode, regrowth of acclimated biomass may be needed periodically. This may require addition of the target organic compound, but not into a process that goes to the effluent. In one or more embodiments, the effluent 142 from the acclimating seed reactors may be directed to the influent 101 of the full wastewater treatment facility 100. Additionally, or in the alternative, at least a portion of the effluent 142 from the acclimating seed reactors may be directed downstream of the bioreactor 112 and solids separation unit 114 for further downstream processing.

Accordingly, the facilities depicted in FIGS. 2 and 3 have been observed to provide a more robust and resilient secondary treatment that improves removal efficiencies of slowly biodegradable and low molecular weight organic compounds. Furthermore, the inventive facilities described herein can reduce the production of disinfection byproducts and TOC in the treated water effluent. Consequently, the treated water stream can exhibit a reduction in whole effluent toxicity.

In this description and the attachments, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth in any related regular utility applications. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in FIGS. 2 and 3, it is noted that equivalents may be employed and substitutions made herein without departing from the scope of the invention.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein and in any related applications, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

### NUMERICAL RANGES

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A method for removing low molecular weight compounds from wastewater, the method comprising:
(a) introducing an initial wastewater stream into a bioreactor to form a first treated wastewater stream, wherein the initial wastewater stream comprises a first low molecular weight compound content;
(b) introducing the first treated wastewater stream into a solids separation unit to form a clarified wastewater stream;
(c) treating at least a portion of the clarified wastewater stream in a seed reactor to thereby form a treated sludge byproduct;
(d) treating at least a portion of the treated sludge byproduct in the bioreactor to form a second treated wastewater;
(e) treating at least a portion of the second treated wastewater in a granular activated carbon (“GAC”) system to thereby form a GAC-treated stream; and
(f) treating at least a portion of the GAC-treated stream in an oxidation system to thereby form a treated water stream comprising a second low molecular weight compound content, wherein the second low molecular weight compound content is at least 90 percent lower than the first low molecular weight compound content.

2. The method according to claim 1, further comprising, prior to the treating of step (c), combining a target compound stream with at least a portion of the clarified wastewater stream.

3. The method according to claim 2, wherein the target compound stream comprises acetone, formaldehyde, methanol, ethanol, or a combination thereof.

4. The method according to claim 3, wherein the target compound stream comprises 75 to 200 mg/L COD equivalent of acetone and formaldehyde, 75 to 200 mg/L COD equivalent of formaldehyde, 75 to 200 mg/L COD equivalent of acetone, 75 to 200 mg/L COD equivalent of methanol, or 75 to 200 mg/L COD equivalent of ethanol.

5. The method according to claim 1, further comprising, prior to the treating of step (e), treating at least a portion of the second treated wastewater stream in the solids separation unit to form a second clarified stream.

6. The method according to claim 5, further comprising introducing at least a portion of the second clarified stream into the seed reactor.

7. The method according to claim 1, further comprising, prior to the treating of step (e), treating at least a portion of the second treated wastewater stream in a membrane system to thereby form a microfiltrated stream.

8. The method according to claim 7, further comprising, prior to the treating of step (e), treating at least a portion of the microfiltrated stream in a reverse osmosis system to thereby form an RO-treated stream, wherein the RO-treated stream is the second treated wastewater stream treated in the GAC system.

9. The method according to claim 1, wherein the seed reactor comprises a sequencing batch reactor or a biofilm reactor.

10. The method according to claim 1, wherein the method does not include an ozone treatment and a biologically activated carbon treatment.

11. A method for removing low molecular weight compounds from wastewater, the method comprising:
(a) introducing an initial wastewater stream into a bioreactor to form a first treated wastewater stream, wherein the initial wastewater stream comprises a first low molecular weight compound content, wherein the low molecular weight compounds comprise acetone, formaldehyde, carbamazepine, sulfamethoxazole, or a combination thereof;
(b) introducing at least a portion of the first treated wastewater stream into a solids separation unit to form a first clarified wastewater stream;
(c) treating at least a portion of the clarified wastewater stream in a seed reactor to thereby form a treated sludge byproduct;
(d) treating at least a portion of the treated sludge byproduct in the bioreactor to form a second treated wastewater;
(e) treating at least a portion of the second treated wastewater in the solids separation unit to thereby form a second clarified wastewater stream;
(f) optionally introducing at least a portion of the second clarified wastewater stream into the seed reactor;
(g) treating at least a portion of the second clarified wastewater stream in a membrane system to thereby form a microfiltrated stream;
(h) treating at least a portion of the microfiltrated stream in a reverse osmosis (“RO”) system to thereby form an RO-treated stream;
(i) treating at least a portion of the RO-treated stream in a granular activated carbon (“GAC”) system to thereby form a GAC-treated stream; and
(j) treating at least a portion of the GAC-treated stream in an oxidation system to thereby form a treated water stream comprising a second low molecular weight compound content, wherein the second low molecular weight compound content is at least 90 percent lower than the first low molecular weight compound content.

12. The method according to claim 11, further comprising, prior to the treating of step (c), combining a target compound stream with at least a portion of the clarified wastewater stream.

13. The method according to claim 12, wherein the target compound stream comprises acetone, formaldehyde, methanol, ethanol, or a combination thereof.

14. The method according to claim 13, wherein the target compound stream comprises 75 to 200 mg/L COD equivalent of acetone and formaldehyde, 75 to 200 mg/L COD equivalent of formaldehyde, 75 to 200 mg/L COD equivalent of acetone, 75 to 200 mg/L COD equivalent of methanol, or 75 to 200 mg/L COD equivalent of ethanol.

15. The method according to claim 11, wherein the seed reactor comprises a sequencing batch reactor or a biofilm reactor.

16. The method according to claim 11, wherein the method does not include an ozone treatment and a biologically activated carbon treatment.

17. A wastewater treatment system for removing low molecular weight compounds from wastewater, the system comprising:
(a) a bioreactor configured to receive an initial wastewater stream and thereby form a first treated wastewater stream, wherein the initial wastewater stream comprises a first low molecular weight compound content, wherein the low molecular weight compounds comprise acetone, formaldehyde, carbamazepine, sulfamethoxazole, or a combination thereof;
(b) a solids separation unit in downstream fluid communication with the bioreactor and configured to receive at least a portion of the first treated wastewater stream and thereby form a clarified wastewater stream;
(c) a seed reactor configured to treat at least a portion of the clarified wastewater stream and thereby form a treated sludge byproduct, wherein the seed reactor is in fluid communication with the bioreactor and the solids separation unit, wherein the bioreactor is configured to receive and treat at least a portion of the treated sludge byproduct from the seed reactor;
(d) a granular activated carbon (“GAC”) system in downstream fluid communication with the solids separation unit and configured to receive and treat at least a portion of the clarified wastewater stream and thereby form a GAC-treated stream; and
(e) an oxidation system configured to receive and treat at least a portion of the GAC-treated stream and thereby form a treated water stream comprising a second low molecular weight compound content, wherein the second low molecular weight compound content is at least 90 percent lower than the first low molecular weight compound content.

18. The system according to claim 17, wherein the seed reactor comprises a sequencing batch reactor or a biofilm reactor.

19. The system according to claim 17, wherein the system does not contain an ozone treatment system and a biologically activated carbon system.

20. The system according to claim 17, further comprising: (i) a microfiltration system downstream of the solids separation unit and upstream of the GAC system, and (ii) a reverse osmosis system downstream of the microfiltration system and upstream of the GAC system.
